(19) United States
(12) Patent Application Publication
(10) Pub. No.: US 2002/0071715 A1
(43) Pub. Date: Jun. 13, 2002

(54) Dual swivel saddle spacer

(75) Inventor: Gerard G. Geiger, Jackson, WI (US)

Correspondence Address: RYAN KROMHOLZ & MANION , S.C., Post Office Box 26618, Milwaukee, WI, 53226-0618, US

(73) Assignee: HellermannTyton Corporation

(21) Appl. No.: 09/952,324

(22) Filed: Sep. 14, 2001

Related U.S. Application Data
(60) Provisional application No. 60/232,364, filed on Sep. 14, 2000.
(60) Provisional application No. 60/184,297, filed on Feb. 23, 2000.

(51) Int. Cl. F16D 1/12; F16D 3/00; F16C 11/00

(52) U.S. Cl. 403/119

(57) ABSTRACT

A dual swivel saddle spacer assembly for use in securing and spacing a first bundle to a second bundle in angular crossing relationship to another. The assembly includes at least one saddle support member supported by and rotatable relative to a pivot pin member. Two saddle supports may be interposed between a rotatable pivotal pin. The pivot pin may comprise a separate structure or it may be integral to one of the saddle support members. The assembly includes one or more elongate slotted openings for receiving a securing device such as a conventional cable tie.

### RELATED APPLICATION

This application claims the benefit of provisional application Serial No. 60/232,364, filed Sep. 14, 2000, which claims the benefit of provisional application Serial No. 60/184,297, filed Feb. 23, 2000.

### BACKGROUND OF THE INVENTION

This invention relates generally to specialized supports for use with cable ties and, more particularly, to a pair of saddles that can be used, for example, with cable ties to secure wires cables, hoses and tubing, hereinafter referred to as bundles, in angular or crossing relationship to one another. The invention further prevents the crossing bundles from rubbing or abrading each other by providing spacing between the bundles.

Molded plastic cable ties are known in the art and are used to secure wires, cables, hoses, tubing, or other elongate articles in tight bundles.

Presently, spacing supports used in conjunction with cable ties are limited to configurations in which the bundles to be secured must be in parallel alignment. This alignment attitude is sufficient when the bundles are to be run along each other or a common parallel surface, such as a truck frame or tractor-trailer bed, however, spacing supports of this type are impractical when it is necessary to secure the bundles in a nonparallel orientation.

### SUMMARY OF THE INVENTION

The present invention seeks to solve the above-mentioned problems by providing a spacing support assembly for use in securing a first bundle to a second bundle in angular relationship. The assembly includes a pair of saddle support members. In one embodiment a rotatable pivot pin is formed in a first member. In another embodiment, each member is attached to a separate rotatable pivot pin or disc member. The saddle supports are preferably interposed between one bundles to be supported and the pivot pin or disc member.

In the preferred embodiment the saddle support assembly is comprised of two members, each having a mating portion and at least one having a saddle portion. The first member has an integrally formed axially extending pivot pin and a primary, radially extending, flange portion, said pivot pin including, proximate to its distal end, a secondary radially extending flange portion or head. The second mating portion includes a centrally located undercut collar having a mating interior configuration to rotatably engage the head of the pivot pin. The saddle portion is provided with a slotted aperture adapted to receive a conventional cable tie having a longitudinal strap portion and a locking head portion. The strap portion is arranged to circumferentially wrap the bundle to be secured. The head portion of the cable tie includes at least one opening there through for receiving the strap and at least one pawl for securing the strap.

In an alternate embodiment the saddle support member is provided with a centrally located undercut collar having a mating interior configuration to rotatably engage the head of a pivot pin. A disc member has an integrally formed axially extending pivot pin and a primary, radially extending, flange portion, said pivot pin including, proximate to its distal end, a secondary radially extending flange portion or head. The saddle portion is provided with a slotted aperture adapted to receive a conventional cable tie having a longitudinal strap portion and a locking head portion. The strap portion is arranged to circumferentially wrap the bundle to be secured. The head portion of the cable tie includes at least one opening therethrough for receiving the strap and at least one pawl for securing the strap.

In an alternate embodiment, the assembly includes two saddle support members and a double pinned disc interposed therebetween. Each saddle support member is adapted to pivotally receive and attach to the pivot pin and flange portion of the disc member.

The saddle support member of the present invention provides support surfaces. Each support surface is arranged to support and engage a bundle. This support surface is preferably curved to more effectively engage a curved bundle, however it is to be understood that other surface contours may be used if the object to be supported so dictates. In the preferred embodiment, recessed pockets are formed in the curved support surface to permit greater circumferential engagement of the cable tie when wrapped around smaller bundles. In the case of larger bundles, there are provided outwardly projecting side rails to provide better load distribution adjacent the support surfaces.

The invention further includes a method of manufacturing a dual swivel saddle spacer comprising the steps of first molding a first saddle member including a pivot pin. Next, inserting the first saddle member into a second saddle member molding cavity and introducing a molding composition that is allowed to cure in the cavity thereby forming a second saddle member adjacent and interlocked to said pivot pin.

Alternatively, the invention may be described as a method of manufacturing a dual swivel saddle spacer comprising the steps of first molding a disc member having a radially extending, flange portion that provides a tapered shut-off in the mold cavity. Next said molded disc member is inserted into a saddle support molding cavity. A molding composition is introduced and allowed to cure in said molding cavity to independently form said saddle support member adjacent and interlocked to the pivot pin. Upon removing said saddle support member and its retained disc member from said molding cavity, the dual swivel saddle spacer assembly is formed.

Alternatively, the invention may be described as a method of manufacturing a dual swivel saddle spacer comprising the steps of a first molding a disc member having oppositely disposed, integrally formed axially extending pivot portions and a primary, radially extending, disk portion, said pivot portions including, proximate to the respective distal end of each pivot portion, a secondary radially extending flange portion; next locating said molded disc member within a molding cavity and wherein said cavity is configured to form a pair of facing support members each support member having a base surface including a re-entrant bore having an interior configuration adapted to receive and rotatably retain a respective pivot portion and its secondary flange; introducing and curing a molding composition into said molding cavity to independently form said pair of support members adjacent to a respective side of said disc member and surrounding said pivot portion; and removing said pair of support members along with the retained adjacent disc member from said molding cavity.

It is an object of the present invention to provide a rotatable spacing support assembly that is convenient to use and economical in manufacture.

It is a further object of the present invention to provide a rotatable spacing support assembly for use with conventional cable ties to provide spaced-apart, rotatable support of bundled articles.

It is a further object of the present invention to provide a rotatable spacing support assembly to prevent bundles from rubbing against each other.

It is a further object of the invention to provide a rotatable spacing support assembly for use in combination with conventional cable ties that reliably and effectively secures items such as wires into bundles in angular crossing relationship.

### DESCRIPTION OF THE DRAWINGS

FIG. 1 is a perspective view of the spacing support assembly including bundles surrounded with cable ties in phantom.

FIG. 2 is a perspective view of the spacing support assembly showing rotational movement.

FIG. 2a is a perspective view of the spacing support assembly showing the saddle support members in relative alignment and as molded.

FIG. 3 is a side elevational view of the spacing support assembly.

FIG. 4 is an end elevational view of the spacing support assembly.

FIG. 5 is a longitudinal section view of the spacing support assembly and taken along lines 5-5 of FIG. 4.

FIG. 5a is a longitudinal section view of an alternate spacing support assembly similar to the view of FIG. 5.

FIG. 6 is a perspective view of an alternate spacing support assembly and showing the saddle support members in rotated relationship.

FIG. 6a is a perspective view of the spacing support assembly seen in FIG. 6 but showing the saddle support members in relative alignment and as molded.

FIG. 7 is a top plan view of the spacing support assembly shown in FIG. 6a.

FIG. 8 is a longitudinal section view of the spacing support assembly shown in FIGS. 6 and 6a and taken along lines 8-8 of FIG. 7.

FIG. 9 is a cross sectional view of the mold cavities used to produce the disc member of the spacing support assembly.

FIG. 10 is a sectional view of the mold used to form the saddle support member and showing an inserted pre-formed disc in place.

FIG. 11 is a sectional, exploded view of the mold after injecting and further showing the completed spacing support assembly.

FIG. 12 is a perspective view of another alternate embodiment, namely a two-piece spacing support assembly and showing the pieces in rotated relationship.

FIG. 12a is a perspective view of the spacing support assembly seen in FIG. 12, but showing the saddle support members in relative alignment and as molded.

FIG. 13 is a top plan view of the alternate embodiment spacing support assembly shown in FIG. 12a.

FIG. 14 is a longitudinal section view of the alternate embodiment spacing support assembly shown in FIGS. 12 and 12a and taken along lines 14-14 of FIG. 13.

FIG. 15 is a perspective view of another embodiment of a two-piece spacing support assembly and showing the pieces in rotated relationship.

FIG. 15a is a perspective view of the spacing support assembly seen in FIG. 15, but showing the saddle support members in relative alignment and as molded.

FIG. 16 is a side elevational view of the alternate embodiment spacing support assembly shown in FIG. 15a.

FIG. 17 is an end elevational view of the alternate embodiment spacing support assembly shown in FIG. 15a.

FIG. 18 is a longitudinal section view of the alternate embodiment spacing support assembly shown in FIGS. 15 and 15a and taken along lines 18-18 of FIG. 17.

FIG. 19 is a perspective view of the preferred embodiment of a two-piece spacing support assembly and showing the pieces in rotated relationship.

FIG. 19a is a perspective view of the spacing support assembly seen in FIG. 19, but showing the saddle support members in relative alignment and as molded.

FIG. 20 is a top plan view of the spacing support assembly shown in FIG. 19a.

FIG. 21 is a side elevational view of the embodiment spacing support assembly shown in FIG. 19a.

FIG. 22 is an end elevational view of the embodiment spacing support assembly shown in FIG. 19a.

FIG. 23 is a longitudinal section view of the embodiment spacing support assembly shown in FIGS. 19 and 19a and taken along line 23-23 of FIG. 21.

FIG. 24 is a sectional view of the spacing support assembly shown in FIGS. 19 and 19a and taken along line 24-24 of FIG. 22.

FIG. 25 is a cross sectional view of the mold used to form the first saddle support member.

FIG. 25a is a cross section view of the saddle support member 12a including an undercut shut off.

FIG. 25b is a cross section view of the saddle support member 12a including a vertical shut off and a core.

FIG. 26 is a cross sectional view of the mold used to form the second saddle support member and showing an inserted preformed first saddle support member in place.

FIG. 27 is a sectional, exploded view of the mold after injecting and further showing the preferred spacing support member.

### DETAILED DESCRIPTION

Although the disclosure hereof is detailed and exact to enable those skilled in the art to practice the invention, the physical embodiments herein disclosed merely exemplify the invention that may be embodied in other specific structure. While the preferred embodiment has been described, the details may be changed without departing from the invention, which is defined by the claims.

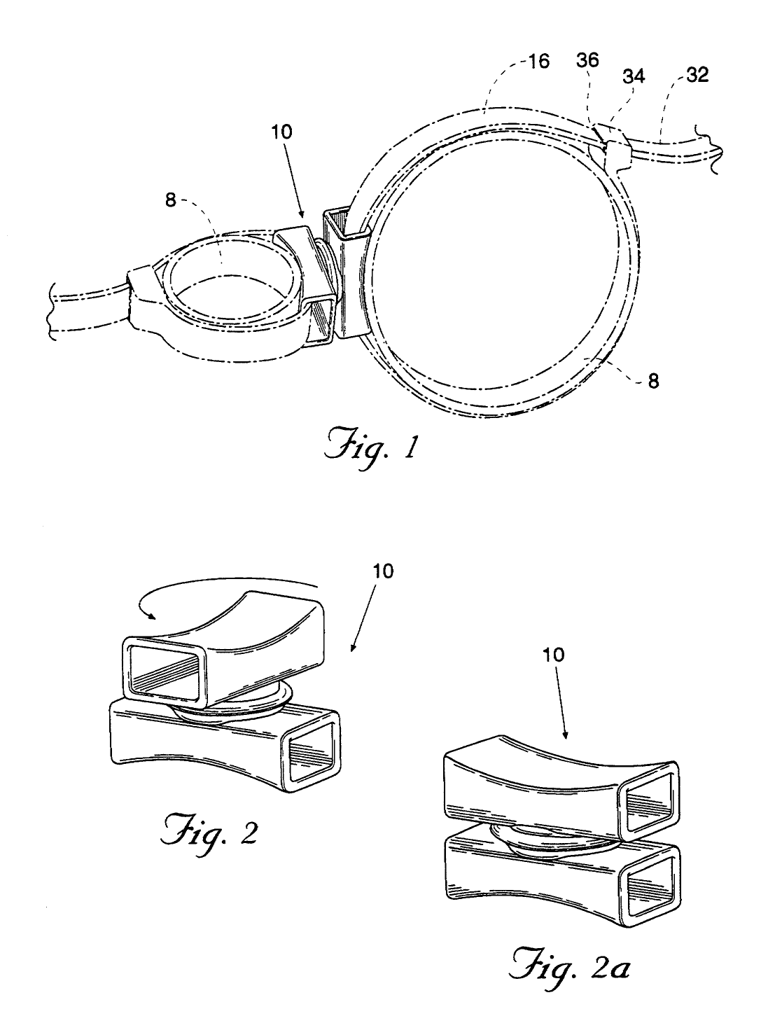

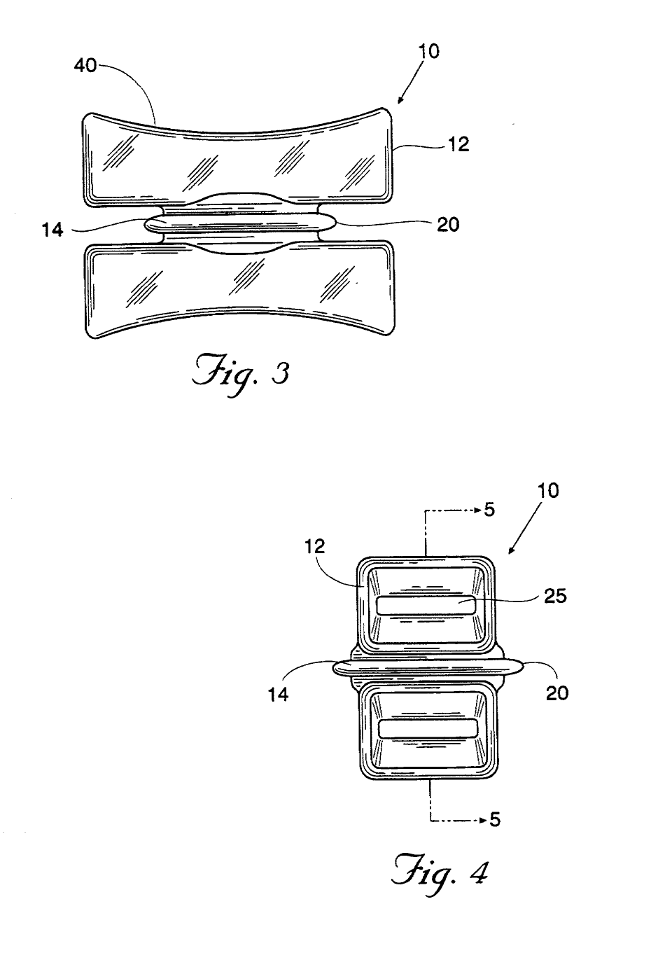

Referring to the drawings, and, in particular to FIGS. 1-4, a spacing support assembly 10 embodying the various features of the invention is shown. The assembly 10 functions to securely space and separate elongate articles, such as wires, cables, hoses, tubing, or other elongate articles into bundles 8 and to secure the bundles 8 in angular crossing alignment with either a second bundle or a supporting structure. It will be apparent that a “bundle” may comprise a bundle of individual wires or cables, rigid or flexible conduit, hot or cold fluid transporting tubes. The “bundle” may also be contained within the bore of a conventional tubular conduit. Referring specifically to FIG. 1, it can be seen that the bundles 8 may be of various sizes and yet be accommodated by the assembly 10. As seen in FIGS. 1 and 2, the assembly 10 is particularly well suited for use in applications in which it is preferred or necessary to secure bundles 8 in a non-parallel manner, for example, at right angles.

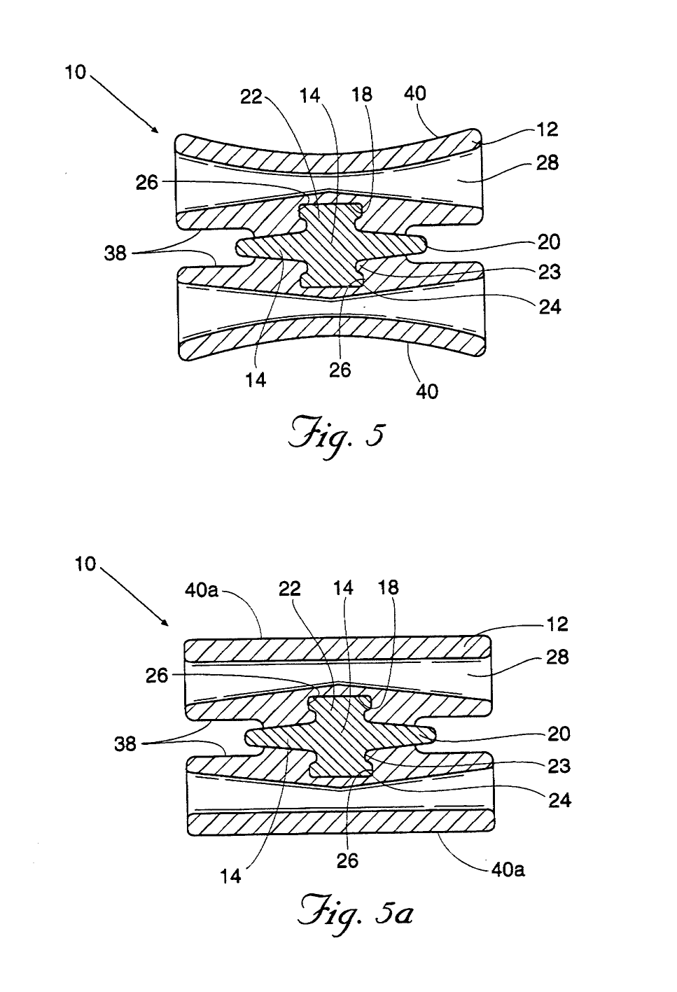

As illustrated in the view of FIG. 5, the assembly 10 includes, in the first embodiment, two principal components, namely a saddle support member 12 and a disc member 14. The assembly 10 of this illustrated embodiment is adapted to receive a pair of crossing opposed bundles 8 gripped by conventional cable ties, seen referenced generally as 16 in FIG. 1, and each bundle 8 is supported and engaged by an individual saddle support member 12. It can be further seen that the disc member 14 is integrally formed and comprises a centrally located pivot pin 18 and a primary, radially extending, flange portion 20. The pivot pin 18 further includes a head portion 22 having an undercut collar 23 and a secondary flange portion 24.

The saddle support member 12 is adapted to be pivotally received and attached to the pivot pin 18 of disc member 14. The saddle support member 12 is provided with a re-entrant bore 26 having an interior configuration adapted to receive and rotatably engage the head 22 of the pivot pin 18. While the re-entrant bore 26 is shown to be centrally located, it is to be understood that it could be located anywhere along saddle support member 12. The saddle support member 12 is further provided with a slotted aperture 28 arranged to receive a conventional cable tie 16. As seen in FIG. 1, the cable tie 16 to be used with the assembly 10 includes a longitudinal strap portion 32 and a locking head portion 34. The locking head 34 is provided with an aperture 36 to receive and retain the strap portion 32.

Preferably the components for the spacing support assembly 10 and cable tie 16 are each injection molded from a strong, durable plastic, such as Nylon 6/6. Further, it can be seen that each saddle support member 12 is integrally formed and comprises a first surface 38 and a second curved support surface 40. The first surface 38 provides clearance between saddles for pivotally receiving and attaching the saddle member 12 to the disc member 14, while the second curved surface 40 is a saddle or cradle arranged for supporting engagement of a bundle 8 (see FIG. 1). Seen best in FIG. 5, the first surface 38 transitions to the re-entrant bore 26 arranged to receive the pivot pin 18 in disc member 14.

In alternate embodiments, the saddle member 12 may have a second surface 40a conforming to the shape of the structure to be supported. As seen in FIG. 5a, for example, the second support surface 40a may be relatively flat to accommodate a non-curved object (not shown).

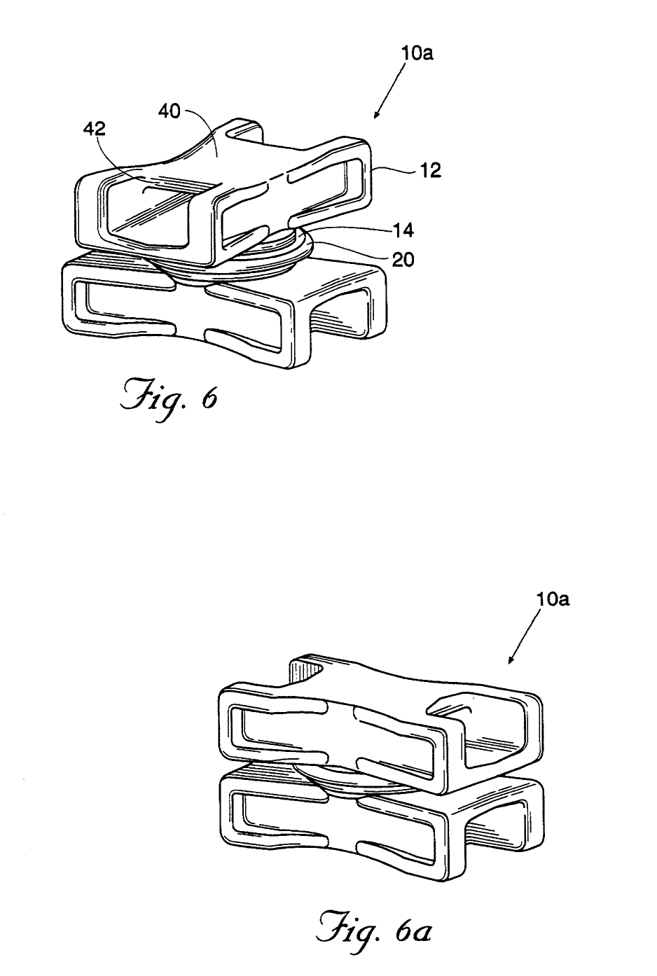

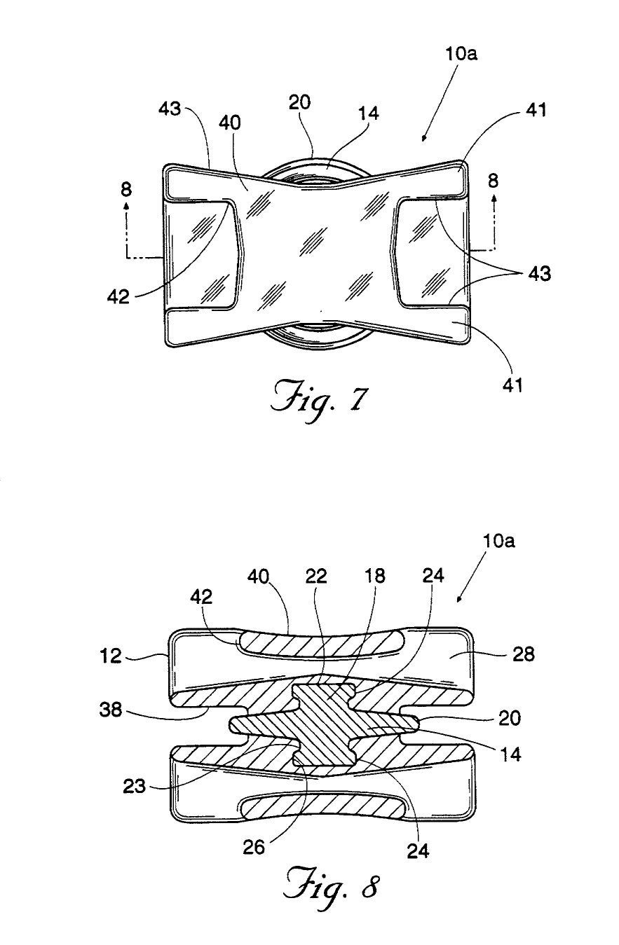

As viewed in FIGS. 6-8, another embodiment of the spacing support assembly 10a is shown. In this embodiment, the second surface 40 is provided with at least one cut-away portion 42. The cut-away portion 42 of the support surface 40 allows bundles 8 (not seen in this view) having small diameters to be better circumferentially wrapped with a cable tie 16 and be effectively secured to the support surface 40. In this embodiment, the strap 32 of cable tie 16 can be drawn into a smaller loop, to accommodate bundles having a smaller diameter than those able to be supported by the support surface 40 of the first embodiment as shown in FIGS. 1-5. Furthermore, the rails 41 extending from the support surface 40 provide additional support when large bundles are secured. The flaring out 43 best seen in FIG. 7 of the rails 41 increases the surface contact to spread the load distribution and reduce pinching.

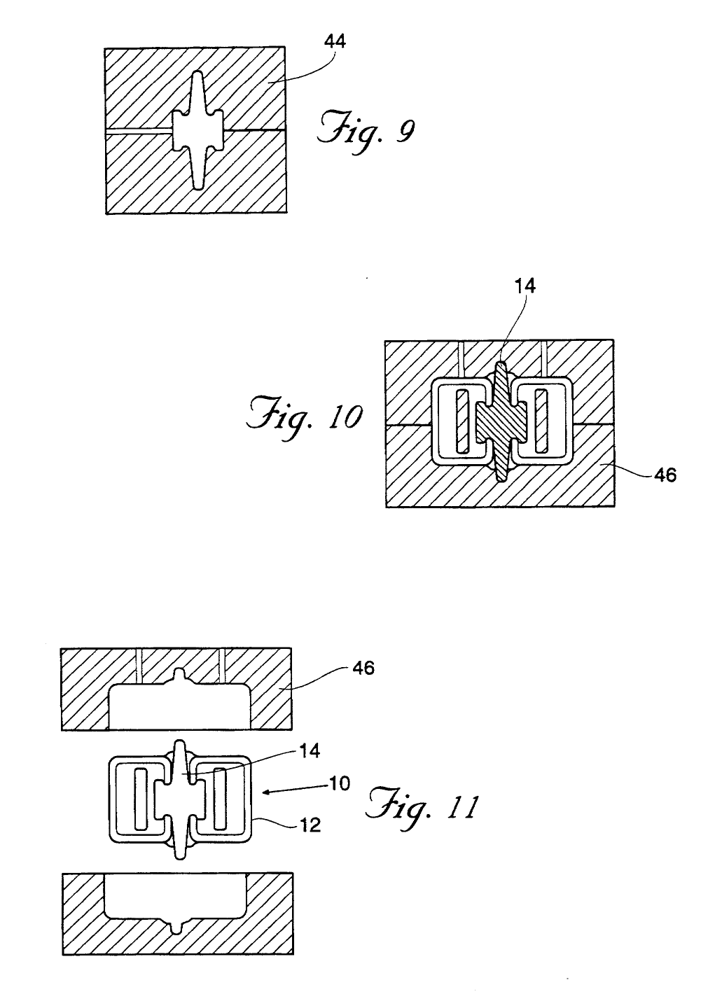

The spacing support assembly 10 is preferably injection molded in a two-step process. As seen in FIGS. 9-11, the disc member 14 is formed prior and independently of the saddle member 12. A disc mold 44 is injected with material, such as plastic. After cooling, the disc member 14 is removed from the disc mold 44 and placed in the saddle member mold 46. While it is preferred that the disc member 14 be molded in this manner, it is to be understood that other production means may be used, including, but not limited to, metal casting, cold forming, formed with a lathe or screw machine, formed from powdered metal, glass, wood or other materials. The saddle support member 12 is formed around the pre-formed disc member 14 as the saddle member mold 46 is injected with material. The material may be the same as that used to form the disc member or may be a material having a lower melting temperature. As seen in FIG. 11, the saddle member mold 46 is parted and the spacing support assembly is complete.

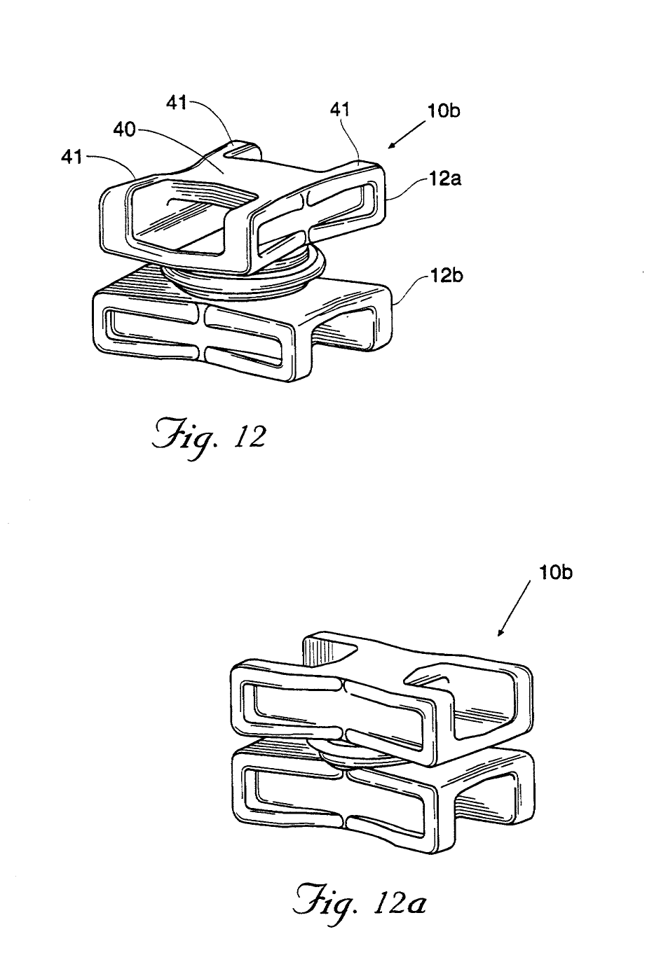

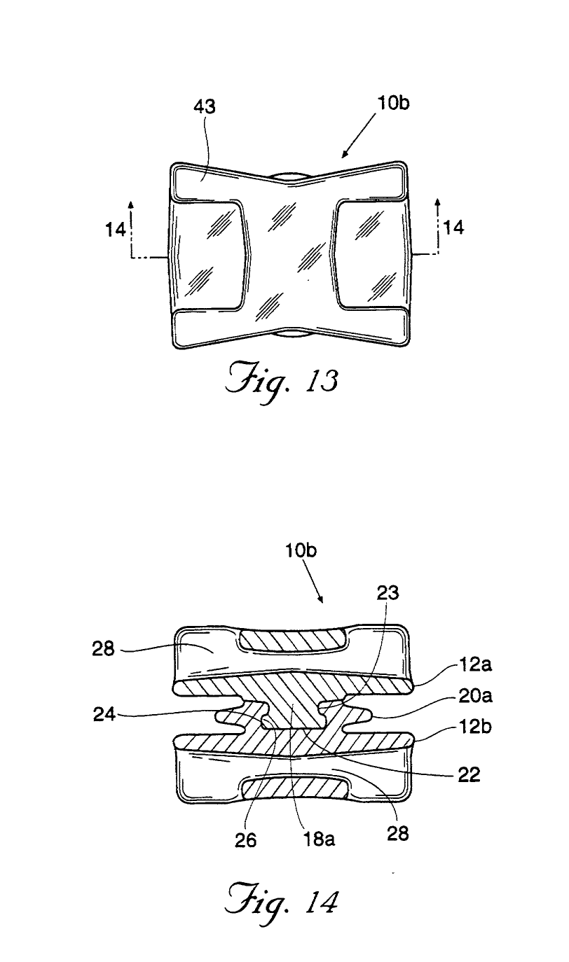

Another alternate embodiment spacing support assembly, referenced generally as 10b, is shown in FIGS. 12-14. In this embodiment, a pivot pin 18a is integrally formed on a saddle support member 12a. Referring to FIG. 14, saddle support member 12a is integrally formed with the pivot pin 18a, while a second saddle support member 12b is provided with a re-entrant bore 26. As in the previously described embodiments, the pivot pin 18a further includes a head portion 22 having an undercut collar 23 and a secondary flange portion 24. The re-entrant bore 26 has an interior configuration adapted to receive and rotatably engage the secondary flange portion 24 of the pivot pin 18a. The saddle support members 12a, 12b are each preferably provided with a slotted longitudinal aperture 28 arranged to receive a conventional cable tie 16.

As shown in FIG. 14, a false flange portion 20a is also formed on saddle member 12b. False flange 20a does not have a functional purpose. It is provided for aesthetic reasons only.

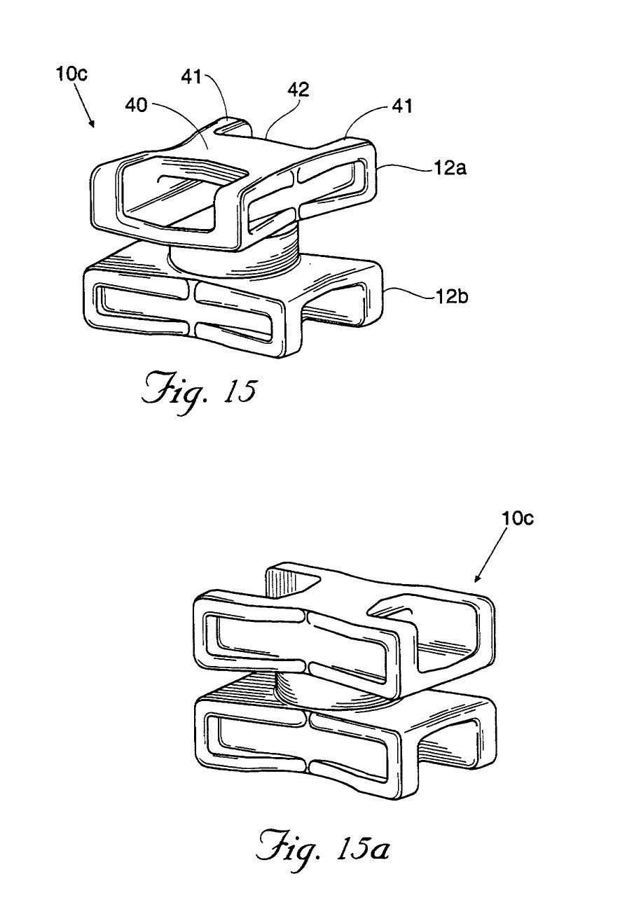

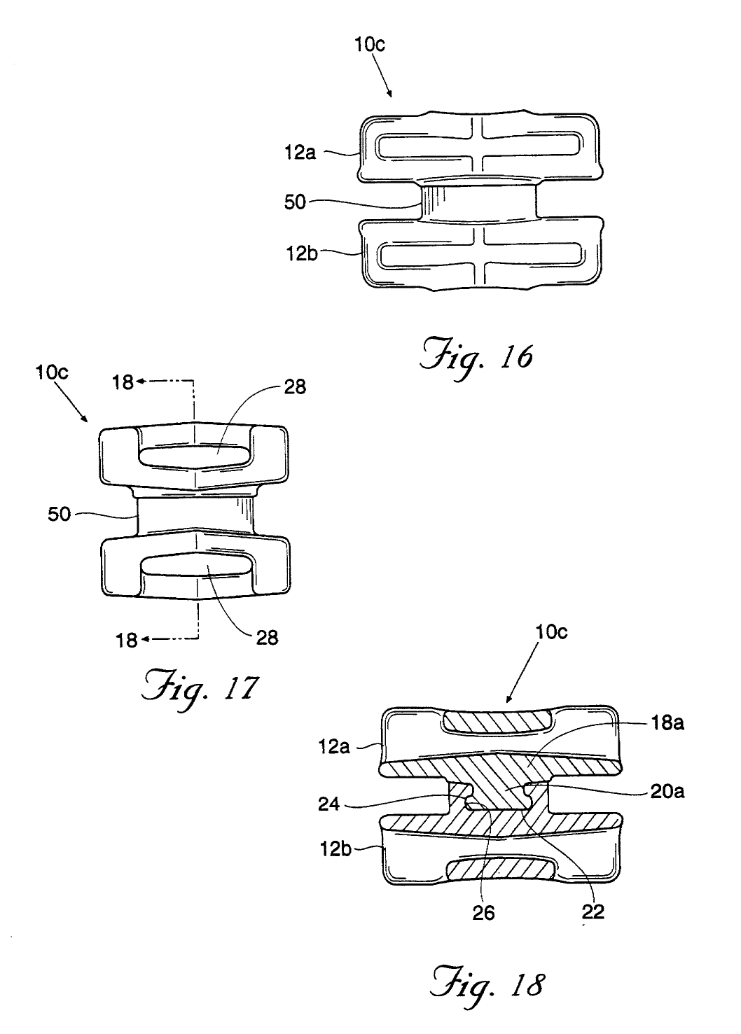

Yet another alternate embodiment spacing support assembly, referenced generally as 10c, is shown in FIGS. 15 through 18. Again in this embodiment, a pivot pin 18a is integrally formed on a first saddle support member 12a. Second saddle support member 12b is provided with a re-entrant bore 26. As in the previously described embodiment, the pivot pin 18a further includes a head portion 22 having an undercut collar 23 and a secondary flange portion 24. The re-entrant bore 26 of saddle member 12b has an interior configuration adapted to receive and rotatably engage the secondary flange portion 24 of the pivot pin 18a. As best shown in FIGS. 16 and 17, a smooth walled cylindrical off-set 50 is formed between the saddle members 12a, 12b. The height of off-set 50, or the distance between the saddle members, will determine the relative spacing of the bundles to be secured. The saddle support members 12a, 12b are each preferably provided with a slotted longitudinal aperture 28 arranged to receive conventional cable tie 16.

Again in this embodiment, surface 40 is provided with at least one cut-away portion 42. The cut-away portion 42 of the support surface 40 allows bundles having small diameters to be better circumferentially wrapped with a cable tie and be effectively secured to the support surface 40. As previously described, rails 41 extend from the support surface 40 provide additional support when large bundles are secured. The flaring out of the rails 41 increases the surface contact to spread the load distribution and reduce pinching.

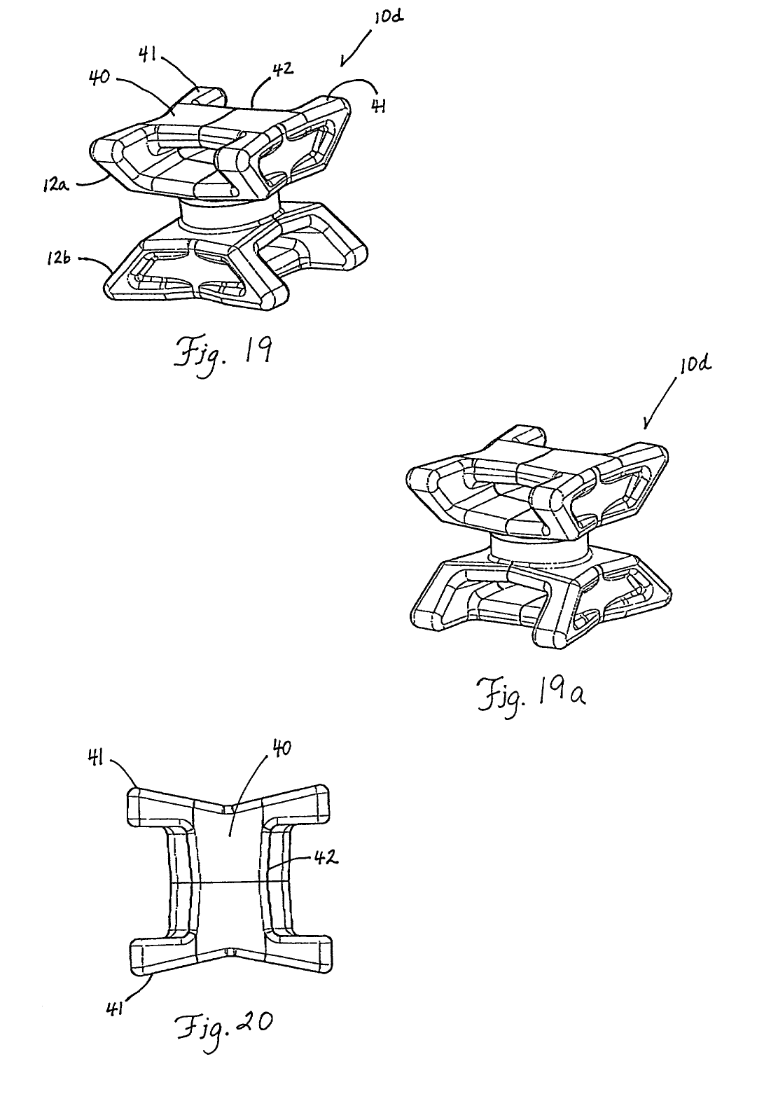

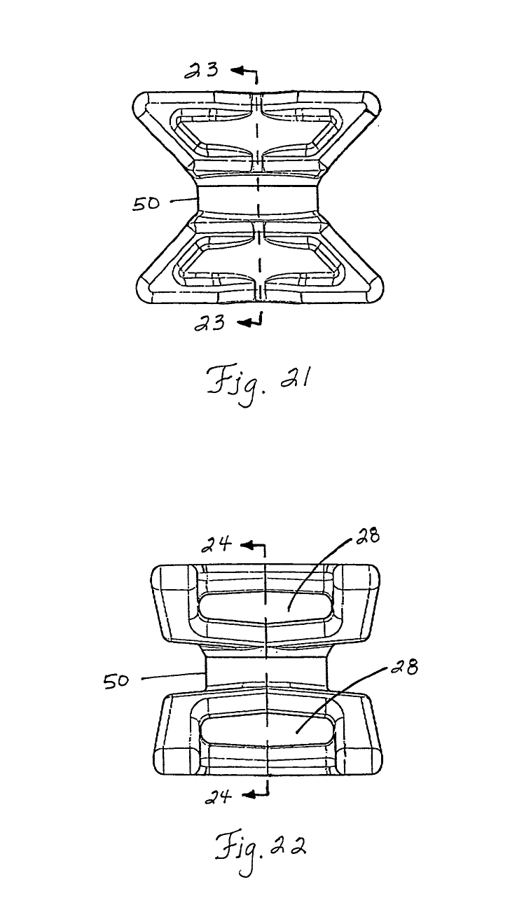

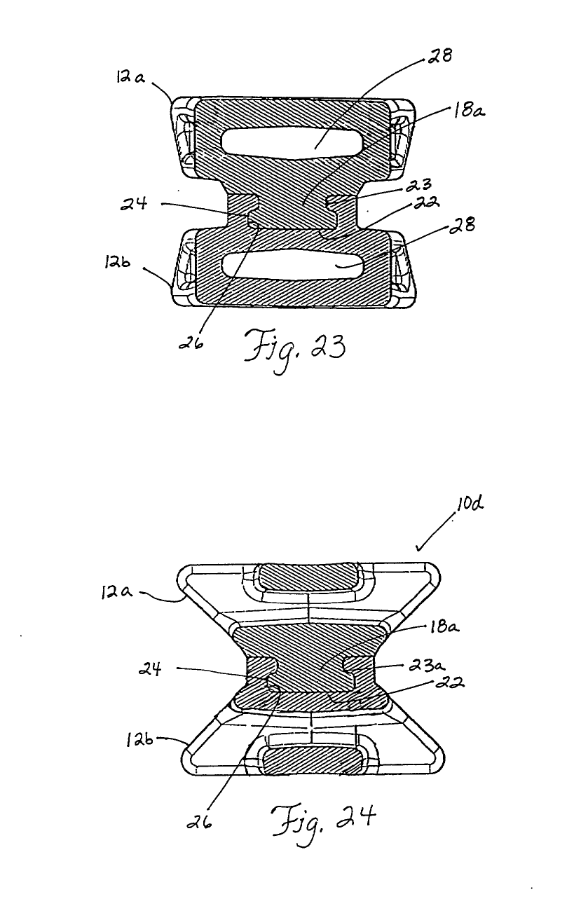

The preferred embodiment of the spacing support assembly, referenced generally as 10d, is shown in FIGS. 19 through 24. Again in this embodiment, a pivot pin 18a is integrally formed on a first saddle support member 12a. Second saddle support member 12b is provided with a re-entrant bore 26. As in the previously described embodiment, the pivot pin 18a further includes a head portion 22 having an undercut collar 23 and a secondary flange portion 24. The re-entrant bore 26 of saddle member 12b has an interior configuration adapted to receive and rotatably engage the secondary flange portion 24 of the pivot pin 18a. As best shown in FIGS. 21 and 22, a smooth walled cylindrical off-set 50 is formed between the saddle members 12a, 12b. The height of off-set 50, or the distance between the saddle members, will determine the relative spacing of the bundles to be secured. The saddle support members 12a, 12b are each preferably provided with a slotted longitudinal aperture 28 arranged to receive conventional cable tie 16.

Again in this embodiment, surface 40 is provided with at least one cut-away portion 42. The cut-away portion 42 of the support surface 40 allows bundles having small diameters to be better circumferentially wrapped with a cable tie and be effectively secured to the support surface 40. As previously described, rails 41 extend from the support surface 40 provide additional support when large bundles are secured. The flaring out of the rails 41 increases the surface contact to spread the load distribution and reduce pinching.

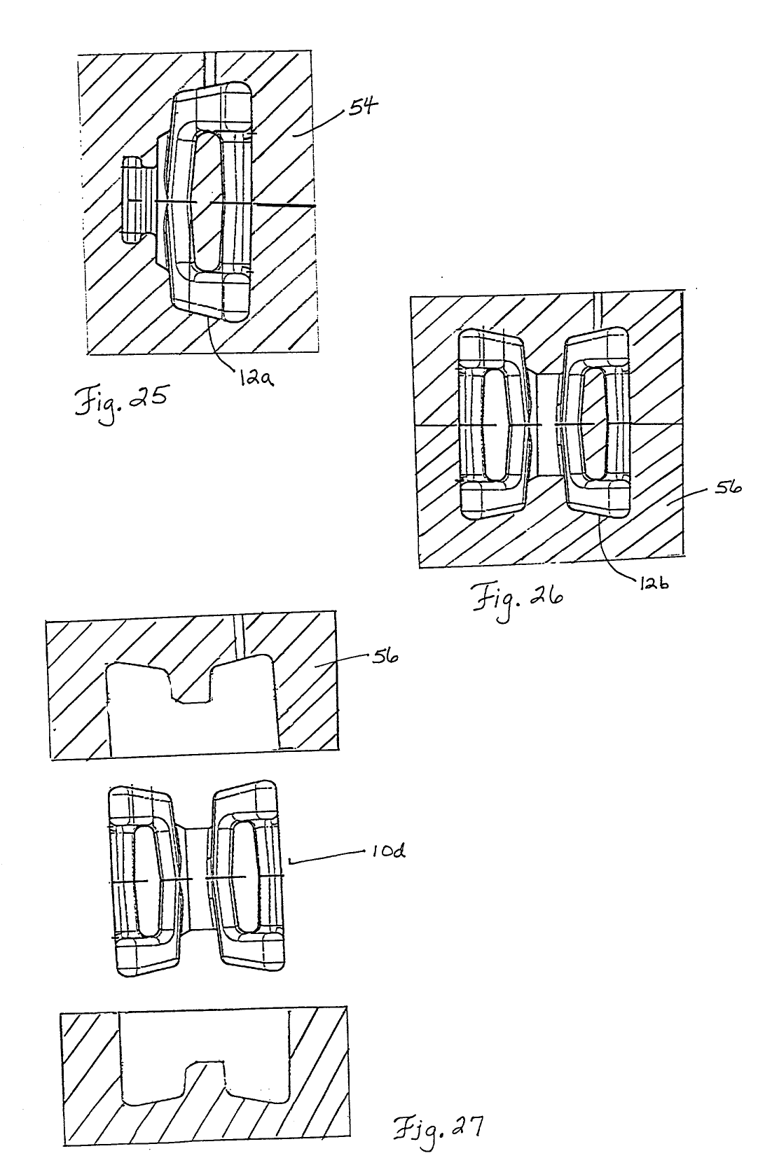

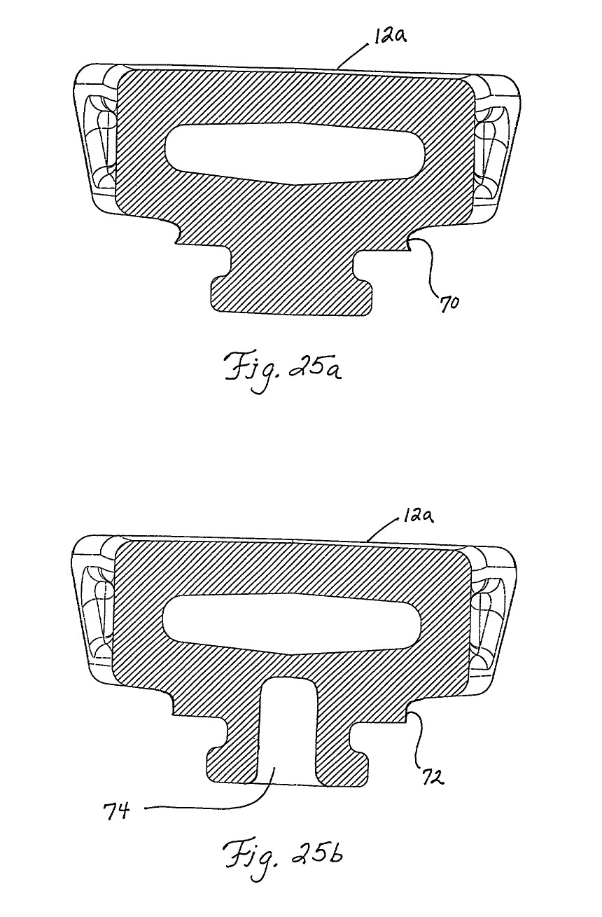

Similar to the previously discussed process, the preferred spacing support assembly 10d is preferably injection molded in a two-step process. As seen in FIG. 25, the first saddle member 12a is formed prior and independently of the second saddle member 12b. A first member mold 54 is injected with material, such as plastic. After cooling, the first member 12a is removed from the disc mold 54 and placed in the second saddle member mold 56. Referring to FIG. 25a, saddle support member is preferably molded with an undercut shut off 70. The undercut shut off 70 allows member 12a to be better retained and also prevents material from flowing into undesirable regions on member 12a during the over molding process discussed infra. Alternatively, and as shown in FIG. 25b, a vertical shut off 72 may be formed. It is also contemplated that a core 74 may be formed in the pivot pin region to allow member 12a to cool faster. This may decrease the total time required to form a finished spacing support assembly 10d.

The second saddle support member 12b is over molded or formed around the pre-formed first member 12a as the second saddle member mold 56 is injected with material. The material may be the same as that used to form the first member or may be a material having a lower melting temperature. As seen in FIG. 27, the second saddle member mold 56 is parted and the spacing support assembly 10d is complete.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A spacing support assembly for securing a first object to a second object said assembly comprising:
a first support member in supporting relationship with said first object;
a second support member in supporting relationship with said second object;
means for pivotally and rotatably connecting said support members relative to one another; and
means for securing said first object to said support member.

2. The spacing support assembly of claim 1 wherein said first support member includes a centrally located pivot portion and wherein said second support member includes means for pivotally receiving and attaching said first support member to said pivot portion of said first support member.

3. The spacing support assembly of claim 2 wherein said means for pivotally receiving and attaching said first support member to said second support member includes a reentrant bore having an interior configuration adapted to receive and rotatably engage said secondary pivot portion.

4. A spacing support assembly including a swivel saddle spacer for securing a first object to a second object, said spacer comprising:
a first support member and a second support member;
each of said support members being pivotally connected by and rotatable relative to each other; and
means for securing said first and second objects to a respective one of said pair of support members.

5. The spacing support assembly of claim 4 wherein said first support member includes an axially extending pivot portion and a radially extending flange portion, and wherein said second support member includes means for pivotally receiving and attaching said first support member to said second support member.

6. The spacing support assembly of claim 5 wherein said means for pivotally receiving and attaching said first support member to said second support member wherein said second support member includes a centrally located reentrant bore having an interior configuration matching said pivot portion.

7. A spacing support assembly including a swivel saddle spacer for securing a first object to a second object said spacer comprising:
a first support member having an axially extending pivot portion;
a second apertured support member, said apertured support member being supported by and rotatable relative to said first support member;
means for securing said first object to said fist support member; and
wherein said means for securing said first object to said support member includes an elongated tie having a strap portion and an apertured locking headed portion, said strap portion being arranged to be received by said aperture of said support member and in locking engagement with said locking headed portion, said strap portion further being arranged to circumscribe and support said first object.

8. A spacing support assembly including a swivel saddle spacer for securing a first object to a second object said spacer comprising:
a pair of support members, said support members each being supported by and rotatable relative to each other;
means for securing said first and said second object to a respective one of said pair of support members; and
wherein said means for securing each of said objects to its respective support member includes an elongated tie having a strap portion and an apertured locking headed portion, said strap portion being arranged to be received by said aperture of said support member and in locking engagement with said locking headed portion, said strap portion further being arranged to circumscribe and support said first object.

9. The spacing support assembly of claim 8 wherein at least one of said support members includes at least one longitudinally extending rail member.

10. A method of manufacturing a swivel saddle spacer comprising the steps of:
forming a fist support member having an integrally formed axially extending pivot portion and a radially extending flange portion;
next locating said first support member within a molding cavity wherein said cavity is configured to form a second support member having a base surface including a reentrant bore having an interior configuration adapted to receive and rotatably retain said pivot portion;
introducing and curing a molding composition into said molding cavity to independently form said second support member adjacent said first support member and surrounding said pivot portion; and
removing said first and second support members from said molding cavity.

11. A method of manufacturing a dual swivel saddle spacer comprising the steps of:
creating a first support member having an integrally formed axially extending pivot portion and a radially extending flange portion;
next locating said first support member within a molding cavity wherein said cavity is configured to form a second support member having a base surface including a reentrant bore having an interior configuration adapted to receive and rotatably retain said pivot portion;
introducing and curing a molding composition into said molding cavity to independently form said second support member adjacent to said first support member and surrounding said pivot portion; and
removing said pair of support members from said molding cavity.

12. A method of manufacturing a dual swivel saddle spacer comprising the steps of:
providing a first support member having an integrally formed axially extending pivot portion and a radially extending flange portion, said pivot portion including a secondary radially extending flange portion;
next locating said first support member within a molding cavity wherein said cavity is configured to form a second support member having a base surface including a reentrant bore having an interior configuration adapted to receive and rotatably retain said pivot portion and its secondary flange;
introducing and curing a molding composition into said molding cavity to independently form said second support member adjacent to said first support member and surrounding said pivot portion; and
removing said pair of support members from said molding cavity.

13. A method of manufacturing a swivel saddle spacer comprising the steps of:
providing a first support member having an integrally formed axially extending pivot portion and a radially extending flange portion, said pivot portion including a secondary radially extending flange portion;
next locating said first support member within a molding cavity wherein said cavity is configured to form a second support member having a base surface including a reentrant bore having an interior configuration adapted to receive and rotatably retain said pivot portion and its secondary flange;
introducing and curing a molding composition into said molding cavity to independently form said second support member adjacent to said first support member and surrounding said pivot portion; and
removing said pair of support members from said molding cavity.

14. A spacing support assembly for securing a first object to a second object said assembly comprising:
a first support member in supporting relationship with said first object;
a second support member in supporting relationship with said second object;
means for pivotally and rotatably supporting said support members relative to one another; and
means for securing said first object to said support member.

15. The spacing support assembly of claim 14 wherein said support members are supported by and rotatable relative to a disc member.

16. The spacing support assembly of claim 15 wherein said disc member includes a centrally located pivot portion and a radially extending flange portion, and wherein said support members each include means for pivotally receiving and attaching said support members to said pivot portion of said disc member.

17. The spacing support assembly of claim 16 wherein said means for pivotally receiving and attaching said support members to said pivot portion includes a secondary flange portion radially extending from a distal end of said pivot portion and wherein said support members each include a centrally located reentrant bore having an interior configuration adapted to receive and rotatably engage said secondary flange portion.

18. A spacing support assembly including a swivel saddle spacer for securing a first object to a second object said spacer comprising:
a pair of support members and a disc member disposed between said support members;
each of said support members being supported by and rotatable relative to said disc member; and
means for securing said first and second objects to a respective one of said pair of support members.

19. The spacing support assembly of claim 18 wherein said disc member includes a pair of oppositely disposed, axially extending, pivot portions and a radially extending, flange portion, and wherein each of said support members includes means for pivotally receiving and attaching said suport member to said pivot portion of said disc member.

20. The spacing support assembly of claim 19 wherein said means for pivotally receiving and attaching each of said support members to each of said pivot portions includes a secondary flange portion radially extending from a distal end of each of said pivot portions and wherein each of said support members includes a centrally located re-entrant bore having an interior configuration matching said secondary flange portion.

21. A spacing support assembly including a swivel saddle spacer for securing a first object to a second object said spacer comprising:
a disc member;
at least one apertured support member, said apertured support member being supported by and rotatable relative to said disc member;
means for securing said first object to said support member; and
wherein said means for securing said first object to said support member includes an elongated tie having a strap portion and an apertured locking headed portion, said strap portion being arranged to be received by said aperture of said support member and in locking engagement with said locking headed portion, said strap portion further being arranged to circumscribe and support said first object.

22. A spacing support assembly including a swivel saddle spacer for securing a first object to a second object said spacer comprising:
a disc member;
a pair of apertured support members, said apertured support members each being supported by and rotatable relative to said disc member;
means for securing said first and said second object to a respective one of said pair of support members; and
wherein said means for securing each of said objects to its respective support member includes an elongated tie having a strap portion and an apertured locking headed portion, said strap portion being arranged to be received by said aperture of said support member and in locking engagement with said locking headed portion, said strap portion further being arranged to circumscribe and support said first object.

23. The spacing support assembly of claim 22 wherein at least one of said support members includes at least one longitudinally extending rail member.

24. A method of manufacturing a swivel saddle spacer comprising the steps of:
first forming a disc member having an integrally formed axially extending pivot portion and a radially extending, flange portion;
next locating said disc member within a molding cavity wherein said cavity is configured to form a support member having a base surface including a reentrant bore having an interior configuration adapted to receive and rotatably retain said pivot portion;
introducing and curing a molding composition into said molding cavity to independently form said support member adjacent said disc member and surrounding said pivot portion; and
removing said support member and its retained adjacent disc member from said molding cavity.

25. A method of manufacturing a dual swivel saddle spacer comprising the steps of:
first creating a disc member having oppositely disposed, integrally formed axially extending pivot portions and a radially extending flange portion;
next locating said disc member within a molding cavity wherein said cavity is configured to form a pair of facing support members each support member having a base surface including a reentrant bore having an interior configuration adapted to receive and rotatably retain a respective pivot portion;
introducing and curing a molding composition into said molding cavity to independently form said pair of support members adjacent to a respective side of said disc member and surrounding said pivot portion; and
removing said pair of support members along with the retained adjacent disc member from said molding cavity.

26. A method of manufacturing a dual swivel saddle spacer comprising the steps of:
providing a disc member having oppositely disposed, integrally formed axially extending pivot portions and a radially extending, flange portion, said pivot portions including, proximate to the respective distal end of each pivot portion, a secondary radially extending flange portion;
next locating said disc member within a molding cavity wherein said cavity is configured to form a pair of facing support members each support member having a base surface including a reentrant bore having an interior configuration adapted to receive and rotatably retain a respective pivot portion and its secondary flange;
introducing and curing a molding composition into said molding cavity to independently form said pair of support members adjacent to a respective side of said disc member and surrounding said pivot portion; and
removing said pair of support members along with the retained adjacent disc member from said molding cavity.

27. A method of manufacturing a swivel saddle spacer comprising the steps of:
providing a disc member having oppositely disposed, integrally formed axially extending pivot portions and a radially extending, flange portion, said pivot portions including, proximate to the respective distal end of each pivot portion, a secondary radially extending flange portion;
next locating said disc member within a molding cavity wherein said cavity is configured to form a pair of facing support members each support member having a base surface including a reentrant bore having an interior configuration adapted to receive and rotatably retain a respective pivot portion and its secondary flange;
introducing and curing a molding composition into said molding cavity to independently form said pair of support members adjacent to a respective side of said disc member and surrounding said pivot portion; and
removing said pair of support members along with the retained adjacent disc member from said molding cavity.
